(19) United States
(12) Patent Application Publication
(10) Pub. No.: US 2026/0065178 A1
(43) Pub. Date: Mar. 5, 2026

(54) SOFTWARE DEPLOYMENT WORKFORCE SELECTION USING SECURITY-BASED POLICY SELECTION

(71) Applicant: Dell Products L.P., Round Rock, TX (US)

(72) Inventors: Igor Dubrovsky, Beer Sheva (IL); Nisan Haimov, Beer Sheva (IL); Boris Shpilyuck, Ashdod (IL)

(21) Appl. No.: 18/816,388

(22) Filed: Aug. 27, 2024

(51) Int. Cl. G06Q 10/0631; G06F 8/60

(52) U.S. Cl. CPC G06Q 10/063112; G06F 8/60; H04Q 3/54583; G06Q 10/101; H04L 47/783

(57) ABSTRACT

Techniques are provided for software deployment workforce selection using security-based policy selection. One method comprises obtaining security skillset grades for workforce personnel associated with a software deployment pipeline; obtaining workforce selection policies that specify a security skillset grade required for workforce personnel; identifying, for a given microservice of an application, a given workforce selection policy applicable to the given microservice, wherein the given workforce selection policy is identified based on a security weight assigned to the given microservice, by aggregating one or more security weights for application programming interfaces of the given microservice; selecting workforce personnel to perform tasks related to the given microservice based on a comparison of the security skillset grades for the workforce personnel and the security skillset grade required for workforce personnel specified in the given workforce selection policy; and initiating at least one automated action based on a result of the selecting.

### BACKGROUND

A number of techniques exist for developing and making changes to software code. GitHub, for example, provides a software development platform that enables communication and collaboration among software developers. It is often important to ensure that the selection and management of software development teams tasked with building and maintaining the software code satisfy one or more requirements.

### SUMMARY

Illustrative embodiments of the disclosure provide techniques for software deployment workforce selection using security-based policy selection. One method includes obtaining one or more data structures comprising data characterizing a plurality of security skillset grades for respective ones of a plurality of workforce personnel associated with at least a portion of a software deployment pipeline; obtaining one or more data structures comprising data characterizing a plurality of workforce selection policies applicable to one or more microservices of an application associated with the software deployment pipeline, wherein the plurality of workforce selection policies specify a security skillset grade required for one or more workforce personnel; identifying, for a given microservice of the application, a given workforce selection policy applicable to the given microservice, wherein the given workforce selection policy is identified based at least in part on a security weight assigned to the given microservice, wherein the security weight assigned to the given microservice is determined by at least one processing device configured to aggregate one or more security weights for respective ones of one or more application programming interfaces of the given microservice; automatically selecting, by the at least one processing device, one or more of the plurality of workforce personnel to perform one or more tasks related to at least a portion of the given microservice, wherein the automatically selecting is based at least in part on a comparison of the plurality of security skillset grades for the respective ones of the plurality of workforce personnel and the security skillset grade required for one or more workforce personnel specified in the given workforce selection policy applicable to the given microservice; and initiating at least one automated action based at least in part on a result of the selecting.

Illustrative embodiments can provide significant advantages relative to conventional techniques. For example, technical problems related to such conventional techniques are mitigated in one or more embodiments by automatically selecting at least portions of a software deployment workforce to satisfy one or more security requirements associated with the software code.

These and other illustrative embodiments described herein include, without limitation, methods, apparatus, systems, and computer program products comprising processor-readable storage media.

### BRIEF DESCRIPTION OF THE DRAWINGS

FIG. 1 illustrates an information processing system configured for software deployment workforce selection using security-based policy selection in an illustrative embodiment;

FIG. 2A shows an example of a software development lifecycle in an illustrative embodiment;

FIG. 2B shows an example of one or more pipeline jobs in various stages of a software deployment pipeline in an illustrative embodiment;

FIG. 3 illustrates a software development system configured for software deployment workforce selection using security-based policy selection in an illustrative embodiment;

FIG. 4 illustrates the workforce compliance engine of FIG. 3 in further detail in accordance with an illustrative embodiment;

FIG. 5 is a sample table illustrating workforce selection policies in an illustrative embodiment;

FIG. 6 is a flow chart illustrating an exemplary implementation of a process for calculating normalized security weights and criticality classifications for microservices in an illustrative embodiment;

FIG. 7 is a flow chart illustrating an exemplary implementation of a process for workforce selection in an illustrative embodiment;

FIG. 8 is a flow chart illustrating an exemplary implementation of a process for workforce compliance and monitoring in an illustrative embodiment;

FIG. 9 is a flow chart illustrating an exemplary implementation of a process for software deployment workforce selection using security-based policy selection, in accordance with an illustrative embodiment;

FIG. 10 illustrates an exemplary processing platform that may be used to implement at least a portion of one or more embodiments of the disclosure comprising a cloud infrastructure; and

FIG. 11 illustrates another exemplary processing platform that may be used to implement at least a portion of one or more embodiments of the disclosure.

### DETAILED DESCRIPTION

Illustrative embodiments of the present disclosure will be described herein with reference to exemplary communication, storage and processing devices. It is to be appreciated, however, that the disclosure is not restricted to use with the particular illustrative configurations shown. One or more embodiments of the disclosure provide methods, apparatus and computer program products for software deployment workforce selection using security-based policy selection.

The term DevOps generally refers to a set of practices that combines software development and information technology (IT) operations. DevOps are increasingly being used to shorten the software development lifecycle and to provide continuous integration, continuous delivery, and continuous deployment. Continuous integration (CI) generally allows development teams to merge and verify changes more often by automating software generation (e.g., converting source code files into standalone software components that can be executed on a computing device) and software tests, so that errors can be detected and resolved early. Continuous delivery extends continuous integration and includes efficiently and safely deploying the changes into testing and production environments. Continuous deployment (CD) allows code changes that pass an automated testing phase to be automatically released into the production environment, thus making the changes visible to end users. Such processes are typically executed within a software generation and deployment pipeline.

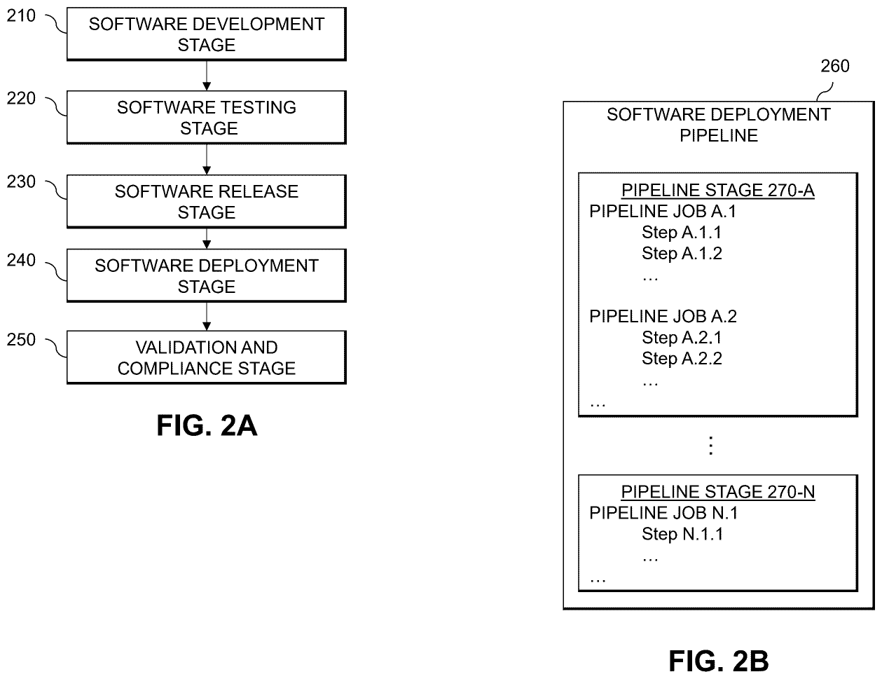

DevOps solutions typically employ blueprints that encompass continuous integration, continuous testing (CT), continuous deployment (also referred to as continuous development) and/or continuous change and management (CCM) abilities. DevOps blueprints allow development teams to efficiently innovate by automating workflows for a software development and delivery lifecycle. A typical software development lifecycle is discussed further below in conjunction with FIG. 2A.

A software deployment pipeline (sometimes referred to as a CI/CD pipeline) automates a software delivery process, and typically comprises a set of automated processes and tools that allow developers and an operations team to work together to generate and deploy application software code to a production environment. A preconfigured software deployment pipeline may comprise a specified set of elements and/or environments. Such elements and/or environments may be added or removed from the software deployment pipeline, for example, based at least in part on the software and/or compliance requirements. A software deployment pipeline typically comprises one or more quality control gates to ensure that software code does not get released to a production environment without satisfying a number of predefined testing and/or quality requirements. For example, a quality control gate may specify that software code should compile without errors or failures and that all unit tests and functional user interface tests must pass.

As noted above, it is often important to ensure that the selection and management of software development teams tasked with building and maintaining the software code satisfy one or more requirements. For example, in some software development environments, there may be requirements to provide evidence that persons that create software, approve pull requests and/or merge software code changes to a production environment have a required level of security skills.

When selecting a team for a secure software development project, it is often important to consider the security skills and expertise of the potential team members in relation to one or more security, compliance and/or confidentiality aspects of the software code associated with the software development project. It is important that the selected team members have the right skills and knowledge to effectively manage and mitigate security risks associated with the software code. In addition, it is also important to monitor, assess and/or adapt the team members with respect to changing security threats and/or a changing environment. Among other benefits, the disclosed techniques for software deployment workforce selection provide a flexible and iterative approach to security that can adapt to changing business requirements and security risks over time. The disclosed software deployment workforce selection techniques automatically match one or more security requirements of a codebase with the skills of potential members of the software deployment workforce. In this manner, a novel framework is provided that automates workforce selection and compliance checking based on the security requirements of the software codebase. By integrating security weights of application programming interfaces (APIs) of one or more microservices, for example, with workforce selection policies, in at least some embodiments, organizations can ensure that only team members with the appropriate skills and expertise are assigned to critical areas of the codebase. Furthermore, automated checks of the software deployment workforce, for example, during the CI/CD process, enforce compliance with workforce selection policies, mitigating the risk of a non-compliant code deployment.

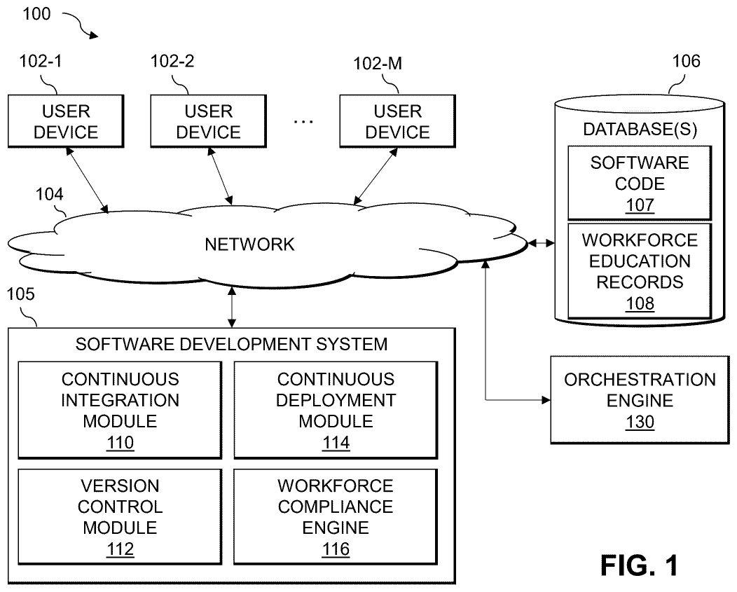

FIG. 1 shows a computer network (also referred to herein as an information processing system) 100 configured in accordance with an illustrative embodiment. The computer network 100 comprises a plurality of user devices 102-1, 102-2, . . . 102-M, collectively referred to herein as user devices 102. The user devices 102 may be employed, for example, by software developers and other DevOps professionals to perform, for example, software development and/or software deployment tasks. The user devices 102 are coupled to a network 104, where the network 104 in this embodiment is assumed to represent a sub-network or other related portion of the larger computer network 100. Accordingly, elements 100 and 104 are both referred to herein as examples of “networks,” but the latter is assumed to be a component of the former in the context of the FIG. 1 embodiment. Also coupled to network 104 is a software development system 105 and an orchestration engine 130.

The user devices 102 may comprise, for example, devices such as mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

The software development system 105 comprises a continuous integration module 110, a version control module 112, a continuous deployment module 114 and a workforce compliance engine 116. Exemplary processes utilizing elements 110, 112, 114 and/or 116 will be described in more detail with reference to, for example, the flow diagrams of FIGS. 2A and 6 through 9.

In at least some embodiments, the continuous integration module 110, the version control module 112, the continuous deployment module 114 and/or the workforce compliance engine 116, or portions thereof, may be implemented using functionality provided, for example, by commercially available DevOps and/or CI/CD tools, such as the GitLab development platform, the GitHub development platform, the Azure DevOps server and/or the Bitbucket CI/CD tool, or another Git-based DevOps and/or CI/CD tool. The continuous integration module 110, the version control module 112 and the continuous deployment module 114 may be configured, for example, to perform CI/CD tasks and to provide access to DevOps tools and/or repositories. The continuous integration module 110 provides functionality for automating the integration of software code changes from multiple software developers or other DevOps professionals into a single software project.

In one or more embodiments, the version control module 112 manages canonical schemas (e.g., blueprints, job templates, and software scripts for jobs) and other aspects of the repository composition available from the DevOps and/or CI/CD tool. Source code management (SCM) techniques may be used to track modifications to a source code repository. In some embodiments, SCM techniques are employed to track a history of changes to a software code base and to resolve conflicts when merging updates from multiple software developers.

The continuous deployment module 114 manages the automatic release of software code changes made by one or more software developers from a software repository to a production environment, for example, after validating the stages of production have been completed.

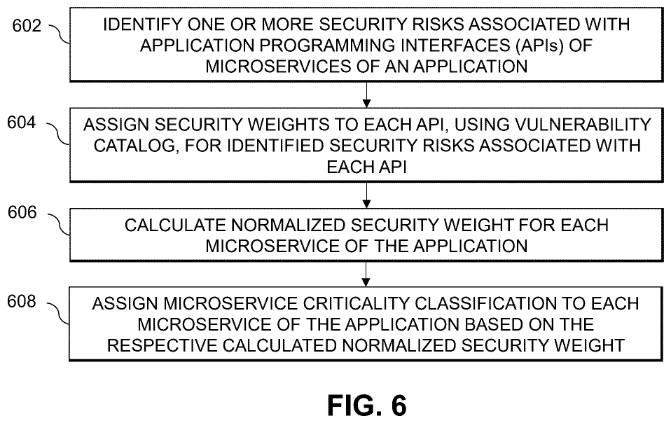

In at least some embodiments, the workforce compliance engine 116 may implement at least portions of the disclosed techniques for software deployment workforce selection using security-based policy selection, as discussed further below in conjunction with, for example, FIGS. 6 through 9.

It is to be appreciated that this particular arrangement of elements 110, 112, 114 and/or 116 illustrated in the software development system 105 of the FIG. 1 embodiment is presented by way of example only, and alternative arrangements can be used in other embodiments. For example, the functionality associated with the elements 110, 112, 114 and/or 116 in other embodiments can be combined into a single module, or separated across a larger number of modules. As another example, multiple distinct processors can be used to implement different ones of the elements 110, 112, 114 and/or 116 or portions thereof.

At least portions of elements 110, 112, 114 and/or 116 may be implemented at least in part in the form of software that is stored in memory and executed by a processor.

In at least some embodiments, the orchestration engine 130 may be implemented, at least in part, using, for example, the functionality of Kubernetes.

In one or more embodiments, the orchestration engine 130 may create execution environments using containers which provide a form of operating system virtualization. One container might be used to run a small microservice or a software process, as well as larger applications. The container provides the necessary executables, binary code, libraries, and configuration files. In some embodiments, the orchestration engine 130 may employ a PKS cluster (e.g., an enterprise Kubernetes platform) that enables developers to provision, operate and/or manage enterprise-level Kubernetes clusters to execute a pipeline job. The Docker open-source containerization platform may be leveraged in some embodiments for building, deploying, and/or managing containerized applications. Docker enables developers to package applications into containers-standardized executable components that combine application source code with operating system libraries and dependencies required to run that code in any environment.

Additionally, the software development system 105 can have at least one associated database 106 configured to store data pertaining to, for example, software code 107 of at least one application and a repository of one or more workforce education records 108 (e.g., comprising a record of classes and continuing education programs, for example, attended by potential workforce members).

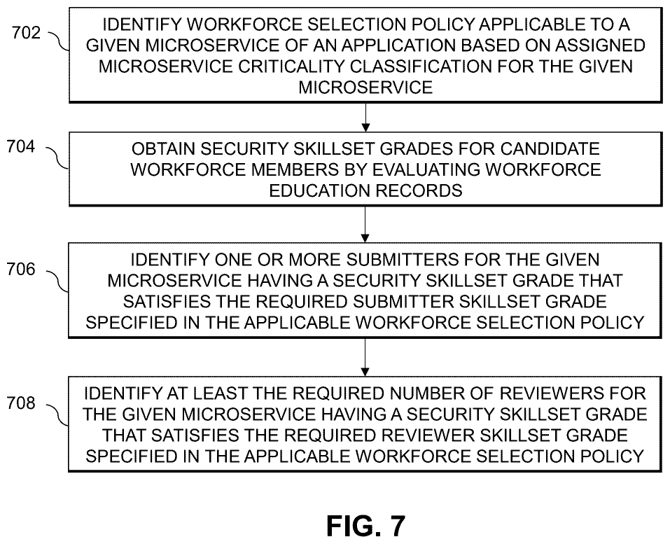

For example, at least a portion of the at least one associated database 106 may correspond to at least one code repository that stores the software code 107. In such an example, the at least one code repository may include different snapshots or versions of the software code 107, at least some of which can correspond to different branches of the software code 107 used for different development environments (e.g., one or more testing environments, one or more staging environments, and/or one or more production environments). The workforce education records 108 provide information characterizing one or more of classes and/or continuing education programs attended by potential workforce members, as discussed further below in conjunction with, for example, FIG. 7.

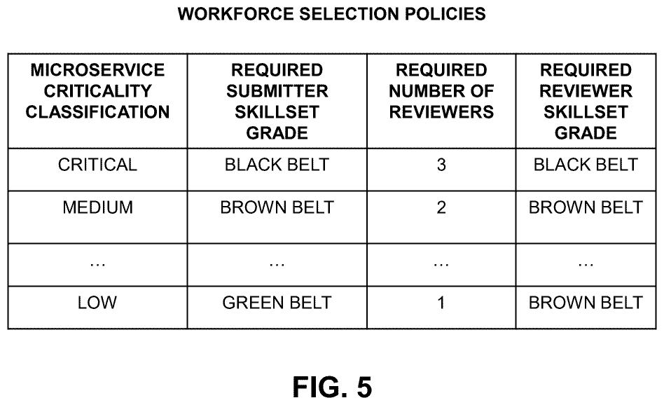

Also, at least a portion of the one or more user devices 102 can also have at least one associated database (not explicitly shown in FIG. 1). As an example, such a database can maintain a particular branch of the software code 107 that is developed in a sandbox environment associated with a given one of the user devices 102, as discussed further below in conjunction with FIG. 5. Any changes associated with that particular branch can then be sent and merged with branches of the software code 107 maintained in the at least one database 106, for example.

An example database 106, such as depicted in the present embodiment, can be implemented using one or more storage systems associated with the software development system 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with the software development system 105 are one or more input-output devices, which illustratively comprise keyboards, displays or other types of input-output devices in any combination. Such input-output devices can be used, for example, to support one or more user interfaces to the software development system 105, as well as to support communication between software development system 105 and other related systems and devices not explicitly shown.

Additionally, the software development system 105 and/or the orchestration engine 130 in the FIG. 1 embodiment are assumed to be implemented using at least one processing device. Each such processing device generally comprises at least one processor and an associated memory, and implements one or more functional modules for controlling certain features of the software development system 105 and/or the orchestration engine 130.

More particularly, the software development system 105 and/or the orchestration engine 130 in this embodiment can comprise a processor coupled to a memory and a network interface.

The processor illustratively comprises a microprocessor, a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the software development system 105 and/or the orchestration engine 130 to communicate over the network 104 with the user devices 102, and illustratively comprises one or more conventional transceivers.

It is to be understood that the particular set of elements shown in FIG. 1 for software development system 105 involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, one or more of the software development system 105 and database(s) 106 can be on and/or part of the same processing platform.

FIG. 2A shows an example of a software development lifecycle in an illustrative embodiment. A software development lifecycle is comprised of a number of stages 210 through 250. In the example of FIG. 2A, a software development stage 210 comprises generating (e.g., writing) the software code for a given application. A software testing stage 220 tests the application software code. A software release stage 230 comprises delivering the application software code to a repository. A software deployment stage 240 comprises deploying the application software code to a production environment. Finally, a validation and compliance stage 250 comprises the steps to validate a deployment, for example, based at least in part on the needs of a given organization. For example, image security scanning tools may be employed to ensure a quality of the deployed images by comparing them to known vulnerabilities, such as those known vulnerabilities in a catalog of common vulnerabilities and exposures (CVEs).

FIG. 2B shows an example of one or more pipeline jobs in various pipeline stages 270-A through 270-N (collectively, pipeline stages 270) of a software deployment pipeline 260 in an illustrative embodiment. The pipeline stages 270-A through 270-N of a software deployment pipeline 260 may correspond, for example, to the stages 210, 220, 230, 240 and 250 of the software development lifecycle of FIG. 2A.

In the example of FIG. 2B, each pipeline stage 270 is comprised of a plurality of pipeline jobs, such as pipeline jobs A.1 and A.2 for pipeline stage 270-A. Each pipeline job is comprised of one or more steps (e.g., tasks, scripts and/or a reference to an external template), such as steps A.1.1 and A.1.2 of pipeline job A.1 and steps A.2.1 and A.2.2 of pipeline job A.2.

In one or more embodiments, a pipeline can comprise one or more of the following elements: (i) local development environments (e.g., the computers of individual developers); (ii) a CI server (or a development server); (iii) one or more test servers (e.g., for functional user interface testing of the product); and (iv) a production environment. The pipelines may be defined, for example, in YAML (Yet Another Markup Language) with a set of commands executed in series to perform the necessary activities (e.g., the steps of each pipeline job).

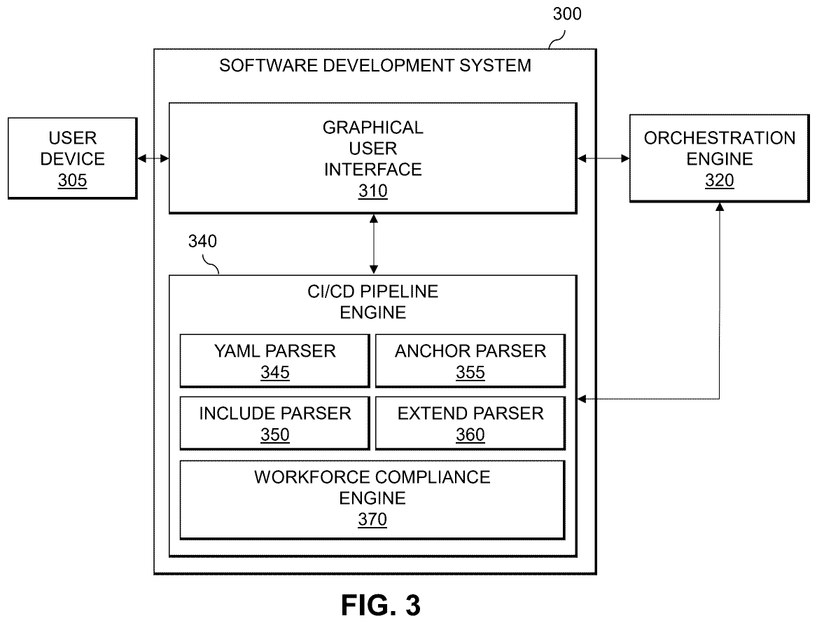

FIG. 3 illustrates a software development system 300 configured for software deployment workforce selection using security-based policy selection, in accordance with an illustrative embodiment. In the example of FIG. 3, the software development system 300 comprises a graphical user interface (GUI) 310 and a CI/CD pipeline engine 340.

In addition, in at least some embodiments, a user employing a user device 305 utilizes the GUI 310 to interact with the software development system 300, such as one or more visual representations of a software deployment pipeline or components thereof (e.g., pipeline jobs). Generally, the GUI 310 provides access to a visual software deployment pipeline editor, a pipeline manager, a DevOps toolkit and a reusable CI/CD resource library, for example.

As shown in FIG. 3, the exemplary CI/CD pipeline engine 340 comprises a YAML parser 345, an include parser 350, an anchor parser 355, an extend parser 360, and a workforce compliance engine 370. The YAML parser 345 processes top-level YAML files obtained from one or more DevOps collaboration tools, for example, for conversion into a renderable format, such as a JSON (JavaScript Object Notation) file format. The include parser 350 processes files referenced in include statements in the YAML file (e.g., whereby a first YAML file calls a second YAML file). The anchor parser 355 processes references in the YAML file, such as variables, images and other configuration items. The extend parser 360 is employed when an include statement specifies a defined job that a user would like to extend (e.g., to extend or otherwise customize a preconfigured job defined, for example, in a blueprint). The workforce compliance engine 370 implements at least portions of the disclosed software deployment workforce selection techniques using security-based policy selection, as discussed further below.

In the example of FIG. 3, the GUI 310 interacts with the exemplary CI/CD pipeline engine 340 and the orchestration engine 320, and the exemplary CI/CD pipeline engine 340 and the orchestration engine 320 also interact with one another, in order to automatically resolve one or more pipeline failures, as discussed further below.

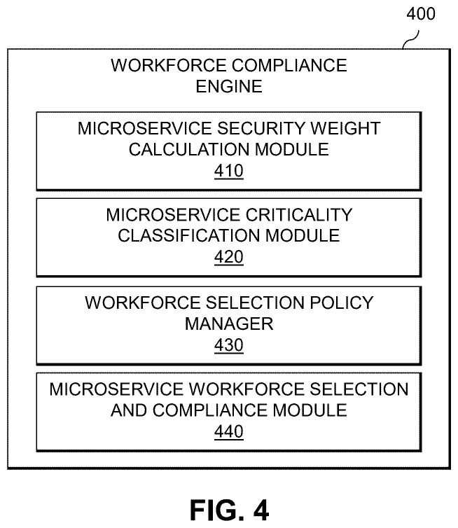

FIG. 4 illustrates the workforce compliance engine of FIG. 3 in further detail in accordance with an illustrative embodiment. In the example of FIG. 4, the workforce compliance engine 400 comprises a microservice security weight calculation module 410, a microservice criticality classification module 420, a workforce selection policy manager 430 and a microservice workforce selection and compliance module 440.

In at least some embodiments, the microservice security weight calculation module 410 assigns security weights to each API of one or more microservices of an application using, for example, a vulnerability catalog for identified risks, as discussed further below in conjunction with FIG. 6, for example. In one or more embodiments, the microservice criticality classification module 420 may assign a microservice criticality classification to each microservice of an application based on a respective calculated normalized security weight, as discussed further below in conjunction with FIG. 6.

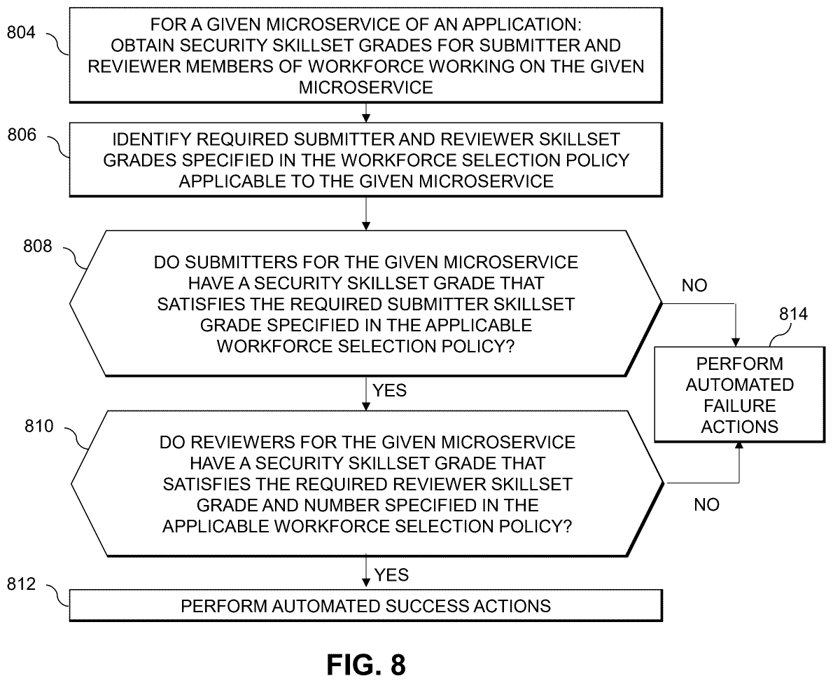

The workforce selection policy manager 430 may identify a workforce selection policy applicable to a given microservice of an application based on the microservice criticality classification assigned to the given microservice by the microservice criticality classification module 420, as discussed further below in conjunction with FIG. 7. In at least some embodiments, the microservice workforce selection and compliance module 440 identifies one or more team members for the given microservice having a security skillset grade that satisfies the required submitter skillset grade specified in the applicable workforce selection policy, and may continue to monitor the assigned team members over time to ensure compliance with the applicable workforce selection policy, as discussed further below in conjunction with FIGS. 7 and 8.

Exemplary processes utilizing elements 410, 420, 430 and/or 440 will be described in more detail with reference to, for example, the flow diagrams of FIGS. 6 through 9. It is to be appreciated that this particular arrangement of elements 410, 420, 430 and/or 440 illustrated in the workforce compliance engine 400 of the FIG. 4 embodiment is presented by way of example only, and alternative arrangements can be used in other embodiments. For example, the functionality associated with the elements 410, 420, 430 and/or 440 in other embodiments can be combined into a single module, or separated across a larger number of modules. As another example, multiple distinct processors can be used to implement different ones of the elements 410, 420, 430 and/or 440 or portions thereof. At least portions of elements 410, 420, 430 and/or 440 may be implemented at least in part in the form of software that is stored in memory and executed by a processor.

FIG. 5 is a sample table illustrating exemplary workforce selection policies in an illustrative embodiment. In the example of FIG. 5, a number of workforce selection policies are illustrated for respective ones of microservice criticality classifications (such as microservice criticality classifications of critical, highly important, important, medium, usual and low criticality, for example). For each indicated workforce selection policy, the table of FIG. 5 identifies the associated criticality classification, a required submitter skillset grade, a required number of reviewers and a required reviewer skillset grade. For example, the skillset grades may be specified as different color belts (such as “Black Belt,” “Brown Belt,” and “Green Belt”), in a similar manner as martial arts belts, or using grades typically employed in educational environments, such as letter grades (e.g., grades of A, B, C, D and F) that cover a range of grades and/or numeric grades (e.g., in a range from 0 to 100). The term “submitter skillset grade,” as used herein, shall be broadly construed to encompass any rating of the education, expertise and/or experience of a given individual or group of individuals, as would be apparent to a person of ordinary skill in the art.

In some embodiments, the workforce selection policies may be represented using a vector, such as [min_submitter_grade, min_reviewers_count, min_reviewers_grade].

FIG. 6 is a flow chart illustrating an exemplary implementation of a process for calculating normalized security weights and criticality classifications for microservices in an illustrative embodiment. In the example of FIG. 6, one or more security risks associated with APIs of microservices of an application are identified in step 602. The one or more security risks may be identified, for example, during a data preparation phase that interacts with security tools and/or security professionals.

Security weights are assigned to each API in step 604, for example, using a vulnerability catalog, for the security risks identified in step 602. The vulnerabilities for the security risks can be obtained from existing vulnerability catalogs (e.g., using a REST API) and/or other data sources (e.g., that identify particular vulnerabilities for particular infrastructure elements). A Common Vulnerability Scoring System (CVSS) may be used, for example, to evaluate the threat level of a given vulnerability and/or to prioritize the security of vulnerabilities. In at least some embodiments, one or more vulnerability catalogs (e.g., glossaries that classify vulnerabilities) are employed that comprise details about known vulnerabilities per API component. Thus, given an API component, it is possible to extract one or more potential vulnerabilities, as well as the corresponding security weights and potential updates that will fix or mitigate such vulnerabilities.

A normalized security weight is calculated in step 606 for each microservice of the application. For example, the normalized security weight of a given microservice may be calculated using the following formula:

$$NSWmicroservice = \frac{SWmicroservice}{{\sum }_{system} SWmicroservice} ,$$

where, NSWmicroservice is the normalized security weight of the given microservice; SWmicroservice is the security weight of the APIs of the given microservice and Σ_{system} SWmicroservice is the sum of the security weights of all microservices in the application.

In step 608, a microservice criticality classification is assigned to each microservice of the application based on the respective calculated normalized security weight from step 608. In this manner, the security weight of APIs of respective microservices is used to identify an appropriate workforce selection policy for each respective microservice, as discussed further below in conjunction with FIG. 7.

FIG. 7 is a flow chart illustrating an exemplary implementation of a process for workforce selection in an illustrative embodiment. In the example of FIG. 7, in step 702, a workforce selection policy applicable to a given microservice of an application is identified based at least in part on the microservice criticality classification assigned to the given microservice in step 608 of FIG. 6. Security skillset grades are obtained in step 704 for candidate workforce members by evaluating workforce education records (e.g., the workforce education records 108 of FIG. 1).

In some embodiments, one or more submitters are identified in step 706 for the given microservice having a security skillset grade that satisfies the required submitter skillset grade specified in the applicable workforce selection policy. At least the required number of reviewers specified in the applicable workforce selection policy for the given microservice, having a security skillset grade that satisfies the required reviewer skillset grade specified in the applicable workforce selection policy, are identified in step 708.

FIG. 8 is a flow chart illustrating an exemplary implementation of a process for workforce compliance and monitoring in an illustrative embodiment. The disclosed techniques for software deployment workforce selection using security-based policy selection include ongoing monitoring of the relationship between the workforce and the security weight of the codebase. In this manner, reports can be provided to the relevant compliance team, ensuring transparency and accountability in security practices.

In the example of FIG. 8, for a given microservice of an application, security skillset grades are obtained in step 804 for the submitter and reviewer members of the workforce working on the given microservice. As noted above, security skillset grades can be obtained for workforce members by evaluating the workforce education records (e.g., the workforce education records 108 of FIG. 1). In step 806, the required submitter and reviewer skillset grades specified in the workforce selection policy applicable to the given microservice are obtained.

A test is performed in step 808 to determine if the submitters for the given microservice have a security skillset grade that satisfies the required submitter skillset grade specified in the applicable workforce selection policy. If the outcome of step 808 is yes, then a further test is performed in step 810 to determine if the reviewers for the given microservice have a security skillset grade that satisfies the required reviewer skillset grade and number specified in the applicable workforce selection policy.

If the outcome of step 808 is no, or if the outcome of step 810 is no, then one or more automated failure actions are performed in step 814. For example, if the submitters or reviewers do not meet the requirements specified in the applicable workforce selection policy, the one or more automated failure actions may comprise failing a build process (or another stage of a software deployment pipeline), indicating that one or more workforce personnel does not meet the necessary security standards. In a further variation, the one or more automated failure actions may comprise suggesting and/or requiring additional training of the deficient workforce members, generating a compliance report or other notification or signal related to the failure and/or controlling a performance of at least one action in another system related to the failure.

If the outcome of step 810 is yes, then one or more automated success actions are performed in step 812. The one or more automated success actions may comprise, for example, generating a compliance report, generating a notification or signal of the successful compliance outcome and/or controlling a performance of at least one action in another system related to the successful outcome.

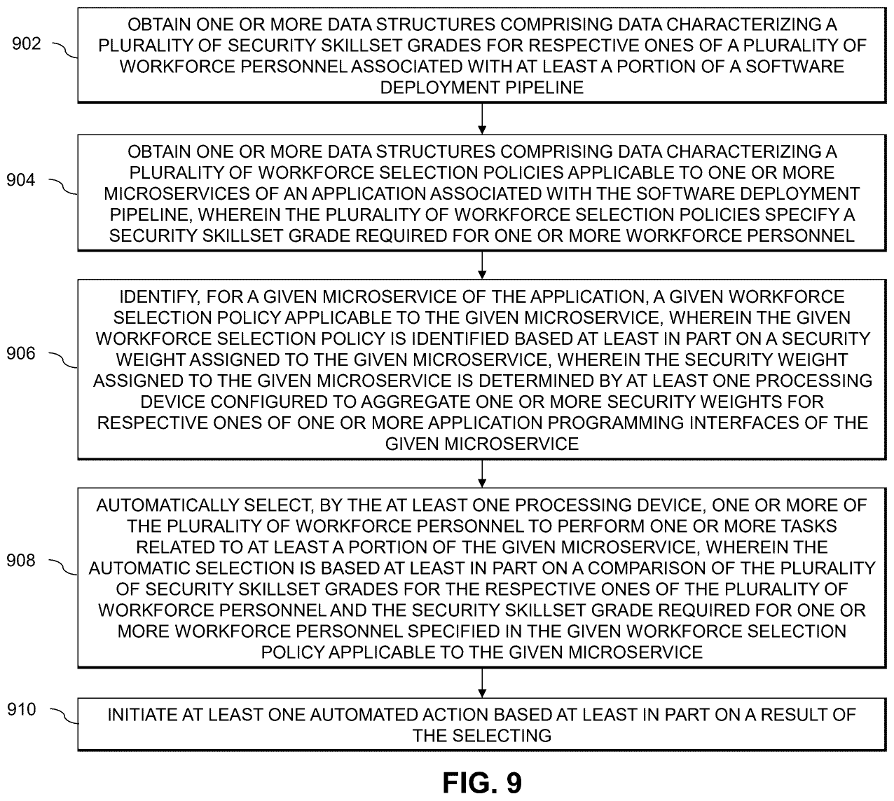

FIG. 9 is a flow chart illustrating an exemplary implementation of a process for software deployment workforce selection using security-based policy selection, in accordance with an illustrative embodiment. In the example of FIG. 9, one or more data structures comprising data characterizing a plurality of security skillset grades for respective ones of a plurality of workforce personnel associated with at least a portion of a software deployment pipeline is obtained in step 902. The term “data structure,” as used herein, is intended to be broadly construed, so as to encompass, for example, a wide variety of different types of tables, arrays, graphs, trees, linked lists, and additional or alternative data relation mechanisms, as well as portions or combinations thereof. Accordingly, a given data structure can comprise a combination of multiple smaller data structures, possibly of different types, or a portion of a larger data structure. Numerous other arrangements are possible, as would be apparent to a person of ordinary skill in the art based on the present disclosure.

One or more data structures comprising data characterizing a plurality of workforce selection policies applicable to one or more microservices of an application associated with the software deployment pipeline is obtained in step 904, where the plurality of workforce selection policies specify a security skillset grade required for one or more workforce personnel.

In step 906, a given workforce selection policy is identified for a given microservice of the application, wherein the given workforce selection policy is identified based at least in part on a security weight assigned to the given microservice, wherein the security weight assigned to the given microservice is determined by at least one processing device configured to aggregate one or more security weights for respective ones of one or more application programming interfaces of the given microservice.

One or more of the plurality of workforce personnel are automatically selected, in step 908, by the at least one processing device, to perform one or more tasks related to at least a portion of the given microservice, wherein the automatic selection is based at least in part on a comparison of the plurality of security skillset grades for the respective ones of the plurality of workforce personnel and the security skillset grade required for one or more workforce personnel specified in the given workforce selection policy applicable to the given microservice.

One or more automated actions are initiated in step 910 based at least in part on a result of the selecting.

In one or more embodiments, the given workforce selection policy specifies a required number of workforce personnel for one or more categories of workforce personnel. The given workforce selection policy may specify at least a first security skillset grade required for a first category of workforce personnel (e.g., workforce submitter personnel) and a second security skillset grade required for a second category of workforce personnel (e.g., workforce reviewer personnel). The at least one automated action may comprise one or more of: generating one or more notifications related to the selection; generating one or more signals related to the selection; and controlling a performance of at least one action in another system using the selection.

In at least one embodiment, the security weight assigned to the given microservice comprises a given microservice criticality classification, of a plurality of microservice criticality classifications, based at least in part on the aggregating the one or more security weights for the respective ones of the one or more application programming interfaces of the given microservice. The one or more security weights for the respective ones of the one or more application programming interfaces of the given microservice may be obtained from one or more vulnerability data sources, and wherein the one or more security weights are associated with respective ones of a plurality of security risks associated with the application programming interfaces of the given microservice.

In some embodiments, the process of FIG. 9 may further comprise determining, for the given microservice of the application, whether one or more of the selected workforce personnel have the security skillset grade specified in the given workforce selection policy applicable to the given microservice. The determining may be performed in response to at least one of the one or more workforce personnel submitting one or more of: (i) a request to review one or more code changes to the given microservice of the application, (ii) a request to merge one or more code changes to the given microservice of the application with a main branch of the given microservice of the application, (iii) a request to approve one or more code changes to the given microservice of the application, (iv) a request to approve a merger of one or more code changes to the given microservice of the application with a main branch of the given microservice of the application and (v) a request to release at least a portion of the software code of the given microservice of the application to a production environment.

The particular processing operations and other network functionality described in conjunction with the flow diagrams of FIGS. 2A and 6 through 9, for example, are presented by way of illustrative example only, and should not be construed as limiting the scope of the disclosure in any way. Alternative embodiments can use other types of processing operations to provide functionality for software deployment workforce selection using security-based policy selection. For example, the ordering of the process steps may be varied in other embodiments, or certain steps may be performed concurrently with one another rather than serially. In one aspect, the process can skip one or more of the steps. In other aspects, one or more of the steps are performed simultaneously. In some aspects, additional steps can be performed.

In one or more embodiments, the disclosed techniques for software deployment workforce selection and compliance provide a flexible and iterative approach to security that can adapt to changing business requirements and risks over time. A novel framework is provided that automates workforce selection and compliance checking based on the dynamic security requirements of the software codebase. Security weights of APIs of one or more microservices are integrated with workforce selection policies, in at least some embodiments, to allow organizations to ensure that only team members with the appropriate skills and expertise are assigned to critical areas of the codebase. Furthermore, automated checks of the software deployment workforce, for example, during the CI/CD process (or otherwise over time), enforce compliance with workforce selection policies, mitigating the risk of a non-compliant code deployment.

It should also be understood that the disclosed techniques for software deployment workforce selection using security-based policy selection can be implemented at least in part in the form of one or more software programs stored in memory and executed by a processor of a processing device such as a computer. As mentioned previously, a memory or other storage device having such program code embodied therein is an example of what is more generally referred to herein as a “computer program product.”

The disclosed techniques for software deployment workforce selection may be implemented using one or more processing platforms. One or more of the processing modules or other components may therefore each run on a computer, storage device or other processing platform element. A given such element may be viewed as an example of what is more generally referred to herein as a “processing device.”

As noted above, illustrative embodiments disclosed herein can provide a number of significant advantages relative to conventional arrangements. It is to be appreciated that the particular advantages described above and elsewhere herein are associated with particular illustrative embodiments and need not be present in other embodiments. Also, the particular types of information processing system features and functionality as illustrated and described herein are exemplary only, and numerous other arrangements may be used in other embodiments.

In these and other embodiments, compute services and/or storage services can be offered to cloud infrastructure tenants or other system users as a Platform-as-a-Service (PaaS) model, an Infrastructure-as-a-Service (IaaS) model, a Storage-as-a-Service (STaaS) model and/or a Function-as-a-Service (FaaS) model, although it is to be appreciated that numerous other cloud infrastructure arrangements could be used.

Some illustrative embodiments of a processing platform that may be used to implement at least a portion of an information processing system comprise cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components such as a cloud-based software deployment workforce selection engine, or portions thereof, are illustratively implemented for use by tenants of such a multi-tenant environment.

Cloud infrastructure as disclosed herein can include cloud-based systems. Virtual machines provided in such systems can be used to implement at least portions of a software deployment workforce selection platform in illustrative embodiments. The cloud-based systems can include object stores.

In some embodiments, the cloud infrastructure additionally or alternatively comprises a plurality of containers implemented using container host devices. For example, a given container of cloud infrastructure illustratively comprises a Docker container or other type of Linux Container. The containers may run on virtual machines in a multi-tenant environment, although other arrangements are possible. The containers may be utilized to implement a variety of different types of functionalities within the storage devices. For example, containers can be used to implement respective processing devices providing compute services of a cloud-based system. Again, containers may be used in combination with other virtualization infrastructure such as virtual machines implemented using a hypervisor.

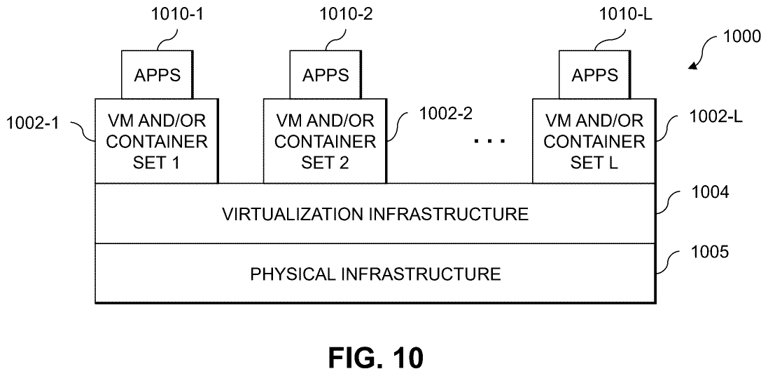

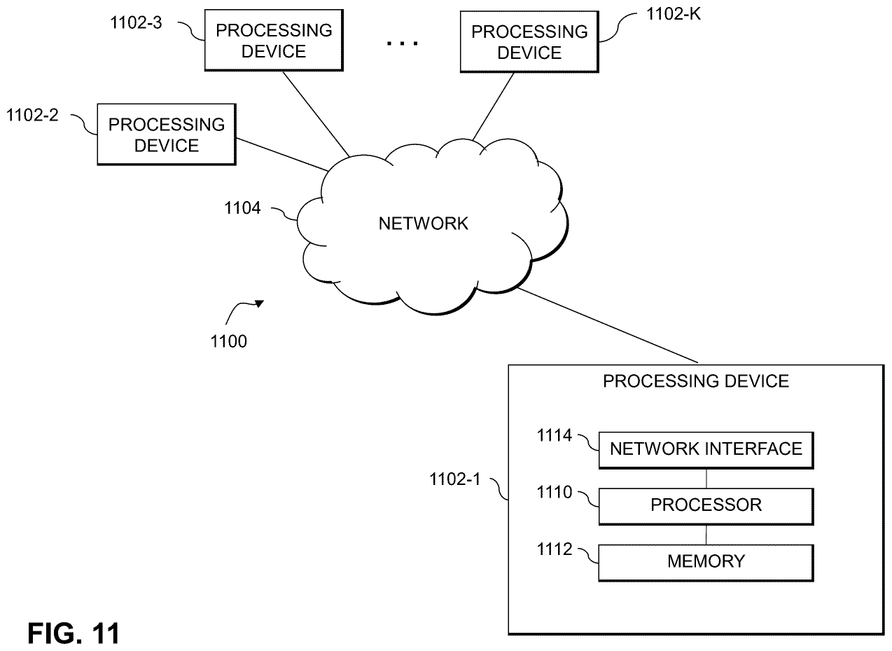

Illustrative embodiments of processing platforms will now be described in greater detail with reference to FIGS. 10 and 11. These platforms may also be used to implement at least portions of other information processing systems in other embodiments.

FIG. 10 shows an example processing platform comprising cloud infrastructure 1000. The cloud infrastructure 1000 comprises a combination of physical and virtual processing resources that may be utilized to implement at least a portion of the information processing system 100. The cloud infrastructure 1000 comprises multiple VMs and/or container sets 1002-1, 1002-2, . . . 1002-L implemented using virtualization infrastructure 1004. The virtualization infrastructure 1004 runs on physical infrastructure 1005, and illustratively comprises one or more hypervisors and/or operating system level virtualization infrastructure. The operating system level virtualization infrastructure illustratively comprises kernel control groups of a Linux operating system or other type of operating system.

The cloud infrastructure 1000 further comprises sets of applications 1010-1, 1010-2, . . . 1010-L running on respective ones of the VMs/container sets 1002-1, 1002-2, . . . 1002-L under the control of the virtualization infrastructure 1004. The VMs/container sets 1002 may comprise respective VMs, respective sets of one or more containers, or respective sets of one or more containers running in VMs.

In some implementations of the FIG. 10 embodiment, the VMs/container sets 1002 comprise respective VMs implemented using virtualization infrastructure 1004 that comprises at least one hypervisor. Such implementations can provide software deployment workforce selection functionality of the type described above for one or more processes running on a given one of the VMs. For example, each of the VMs can implement software deployment workforce selection control logic and associated workforce compliance monitoring functionality for one or more processes running on that particular VM.

An example of a hypervisor platform that may be used to implement a hypervisor within the virtualization infrastructure 1004 is the VMware® vSphere® which may have an associated virtual infrastructure management system such as the VMware® vCenter™. The underlying physical machines may comprise one or more distributed processing platforms that include one or more storage systems.

In other implementations of the FIG. 10 embodiment, the VMs/container sets 1002 comprise respective containers implemented using virtualization infrastructure 1004 that provides operating system level virtualization functionality, such as support for Docker containers running on bare metal hosts, or Docker containers running on VMs. The containers are illustratively implemented using respective kernel control groups of the operating system. Such implementations can provide software deployment workforce selection functionality of the type described above for one or more processes running on different ones of the containers. For example, a container host device supporting multiple containers of one or more container sets can implement one or more instances of software deployment workforce selection control logic and associated workforce compliance monitoring functionality.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 1000 shown in FIG. 10 may represent at least a portion of one processing platform. Another example of such a processing platform is processing platform 1100 shown in FIG. 11.

The processing platform 1100 in this embodiment comprises at least a portion of the given system and includes a plurality of processing devices, denoted 1102-1, 1102-2, 1102-3, . . . 1102-K, which communicate with one another over a network 1104. The network 1104 may comprise any type of network, such as a WAN, a LAN, a satellite network, a telephone or cable network, a cellular network, a wireless network such as WiFi or WiMAX, or various portions or combinations of these and other types of networks.

The processing device 1102-1 in the processing platform 1100 comprises a processor 1110 coupled to a memory 1112. The processor 1110 may comprise a microprocessor, a microcontroller, an ASIC, an FPGA or other type of processing circuitry, as well as portions or combinations of such circuitry elements, and the memory 1112, which may be viewed as an example of a “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1102-1 is network interface circuitry 1114, which is used to interface the processing device with the network 1104 and other system components, and may comprise conventional transceivers.

The other processing devices 1102 of the processing platform 1100 are assumed to be configured in a manner similar to that shown for processing device 1102-1 in the figure.

Again, the particular processing platform 1100 shown in the figure is presented by way of example only, and the given system may include additional or alternative processing platforms, as well as numerous distinct processing platforms in any combination, with each such platform comprising one or more computers, storage devices or other processing devices.

Multiple elements of an information processing system may be collectively implemented on a common processing platform of the type shown in FIG. 10 or 11, or each such element may be implemented on a separate processing platform.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage devices or other components are possible in the information processing system. Such components can communicate with other elements of the information processing system over any type of network or other communication media.

As indicated previously, components of an information processing system as disclosed herein can be implemented at least in part in the form of one or more software programs stored in memory and executed by a processor of a processing device. For example, at least portions of the functionality shown in one or more of the figures are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

1. A computer-implemented method, comprising:
obtaining one or more first data structures comprising data characterizing a plurality of security skillset grades for respective ones of a plurality of workforce personnel associated with at least a portion of a software deployment pipeline;
obtaining one or more second data structures comprising data characterizing a plurality of workforce selection policies applicable to one or more microservices of an application associated with the software deployment pipeline, wherein the plurality of workforce selection policies specifies a security skillset grade required for one or more workforce personnel;
assigning a security weight to a given microservice of the application by performing a processor-based aggregation, using at least one processing device, of one or more security weights for respective ones of one or more application programming interfaces of the given microservice, wherein the one or more security weights are (i) obtained from one or more online data sources and (ii) associated with respective ones of a plurality of security risks associated with the application programming interfaces of the given microservice;
identifying, for the given microservice of the application, a given workforce selection policy, from the one or more second data structures, applicable to the given microservice, wherein the given workforce selection policy is identified based at least in part on the security weight assigned to the given microservice;
automatically selecting, by the at least one processing device, one or more of the plurality of workforce personnel to perform one or more tasks related to at least a portion of the given microservice, wherein the automatically selecting is based at least in part on a processor-based comparison of the plurality of security skillset grades, from the one or more first data structures, for the respective ones of the plurality of workforce personnel and the security skillset grade required for one or more workforce personnel specified in the given workforce selection policy, from the one or more second data structures, applicable to the given microservice; and
automatically initiating at least one automated action in response to an occurrence of at least one designated event,
wherein the at least one designated event comprises at least one of: (i) a request to review one or more code changes to the given microservice of the application, (ii) a request to merge one or more code changes to the given microservice of the application with a main branch of the given microservice of the application, (iii) a request to approve one or more code changes to the given microservice of the application, (iv) a request to approve a merger of one or more code changes to the given microservice of the application with a main branch of the given microservice of the application and (v) a request to release at least a portion of software code of the given microservice of the application to a production environment, and
wherein the at least one automated action comprises (i) verifying, for the given microservice of the application, whether one or more of the selected workforce personnel have the security skillset grade specified in the given workforce selection policy applicable to the given microservice to obtain a security verification result and (ii) automatically denying at least one request associated with the at least one designated event in response to the security verification result;
wherein the at least one processing device comprises a processor coupled to a memory.

2. The computer-implemented method of claim 1, wherein the given workforce selection policy specifies a required number of workforce personnel for one or more categories of workforce personnel.

3. The computer-implemented method of claim 2, wherein the given workforce selection policy specifies at least a first security skillset grade required for a first category of workforce personnel and a second security skillset grade required for a second category of workforce personnel.

4. The computer-implemented method of claim 1, wherein the security weight assigned to the given microservice comprises a given microservice criticality classification, of a plurality of microservice criticality classifications, based at least in part on the aggregating the one or more security weights for the respective ones of the one or more application programming interfaces of the given microservice.

5. (canceled)

6. (canceled)

7. The computer-implemented method of claim 1, wherein the one or more security weights for the respective ones of the one or more application programming interfaces of the given microservice are obtained from one or more vulnerability data sources.

8. The computer-implemented method of claim 1, wherein the at least one automated action comprises one or more of: generating one or more notifications related to the selection; generating one or more signals related to the selection; and controlling a performance of at least one action in another system using the selection.

9. An apparatus comprising:
at least one processing device comprising a processor coupled to a memory;
the at least one processing device being configured to implement the following steps:
obtaining one or more first data structures comprising data characterizing a plurality of security skillset grades for respective ones of a plurality of workforce personnel associated with at least a portion of a software deployment pipeline;
obtaining one or more second data structures comprising data characterizing a plurality of workforce selection policies applicable to one or more microservices of an application associated with the software deployment pipeline, wherein the plurality of workforce selection policies specifies a security skillset grade required for one or more workforce personnel;
assigning a security weight to a given microservice of the application by performing a processor-based aggregation, using at least one processing device, of one or more security weights for respective ones of one or more application programming interfaces of the given microservice, wherein the one or more security weights are (i) obtained from one or more online data sources and (ii) associated with respective ones of a plurality of security risks associated with the application programming interfaces of the given microservice;
identifying, for the given microservice of the application, a given workforce selection policy, from the one or more second data structures, applicable to the given microservice, wherein the given workforce selection policy is identified based at least in part on the security weight assigned to the given microservice;
automatically selecting, by the at least one processing device, one or more of the plurality of workforce personnel to perform one or more tasks related to at least a portion of the given microservice, wherein the automatically selecting is based at least in part on a processor-based comparison of the plurality of security skillset grades, from the one or more first data structures, for the respective ones of the plurality of workforce personnel and the security skillset grade required for one or more workforce personnel specified in the given workforce selection policy, from the one or more second data structures, applicable to the given microservice; and
automatically initiating at least one automated action in response to an occurrence of at least one designated event,
wherein the at least one designated event comprises at least one of: (i) a request to review one or more code changes to the given microservice of the application, (ii) a request to merge one or more code changes to the given microservice of the application with a main branch of the given microservice of the application, (iii) a request to approve one or more code changes to the given microservice of the application, (iv) a request to approve a merger of one or more code changes to the given microservice of the application with a main branch of the given microservice of the application and (v) a request to release at least a portion of software code of the given microservice of the application to a production environment, and
wherein the at least one automated action comprises (i) verifying, for the given microservice of the application, whether one or more of the selected workforce personnel have the security skillset grade specified in the given workforce selection policy applicable to the given microservice to obtain a security verification result and (ii) automatically denying at least one request associated with the at least one designated event in response to the security verification result.

10. The apparatus of claim 9, wherein the given workforce selection policy specifies a required number of workforce personnel for one or more categories of workforce personnel, wherein the given workforce selection policy specifies at least a first security skillset grade required for a first category of workforce personnel and a second security skillset grade required for a second category of workforce personnel.

11. The apparatus of claim 9, wherein the security weight assigned to the given microservice comprises a given microservice criticality classification, of a plurality of microservice criticality classifications, based at least in part on the aggregating the one or more security weights for the respective ones of the one or more application programming interfaces of the given microservice.

12. (canceled)

13. The apparatus of claim 9, wherein the one or more security weights for the respective ones of the one or more application programming interfaces of the given microservice are obtained from one or more vulnerability data sources.

14. The apparatus of claim 9, wherein the at least one automated action comprises one or more of: generating one or more notifications related to the selection; generating one or more signals related to the selection; and controlling a performance of at least one action in another system using the selection.

15. A non-transitory processor-readable storage medium having stored therein program code of one or more software programs, wherein the program code when executed by at least one processing device causes the at least one processing device to perform the following steps:
obtaining one or more first data structures comprising data characterizing a plurality of security skillset grades for respective ones of a plurality of workforce personnel associated with at least a portion of a software deployment pipeline;
obtaining one or more second data structures comprising data characterizing a plurality of workforce selection policies applicable to one or more microservices of an application associated with the software deployment pipeline, wherein the plurality of workforce selection policies specifies a security skillset grade required for one or more workforce personnel;
assigning a security weight to a given microservice of the application by performing a processor-based aggregation, using at least one processing device, of one or more security weights for respective ones of one or more application programming interfaces of the given microservice, wherein the one or more security weights are (i) obtained from one or more online data sources and (ii) associated with respective ones of a plurality of security risks associated with the application programming interfaces of the given microservice;
identifying, for the given microservice of the application, a given workforce selection policy, from the one or more second data structures, applicable to the given microservice, wherein the given workforce selection policy is identified based at least in part on the security weight assigned to the given microservice;
automatically selecting, by the at least one processing device, one or more of the plurality of workforce personnel to perform one or more tasks related to at least a portion of the given microservice, wherein the automatically selecting is based at least in part on a processor-based comparison of the plurality of security skillset grades, from the one or more first data structures, for the respective ones of the plurality of workforce personnel and the security skillset grade required for one or more workforce personnel specified in the given workforce selection policy, from the one or more second data structures, applicable to the given microservice; and
automatically initiating at least one automated action in response to an occurrence of at least one designated event,
wherein the at least one designated event comprises at least one of: (i) a request to review one or more code changes to the given microservice of the application, (ii) a request to merge one or more code changes to the given microservice of the application with a main branch of the given microservice of the application, (iii) a request to approve one or more code changes to the given microservice of the application, (iv) a request to approve a merger of one or more code changes to the given microservice of the application with a main branch of the given microservice of the application and (v) a request to release at least a portion of software code of the given microservice of the application to a production environment, and
wherein the at least one automated action comprises (i) verifying, for the given microservice of the application, whether one or more of the selected workforce personnel have the security skillset grade specified in the given workforce selection policy applicable to the given microservice to obtain a security verification result and (ii) automatically denying at least one request associated with the at least one designated event in response to the security verification result.

16. The non-transitory processor-readable storage medium of claim 15, wherein the given workforce selection policy specifies a required number of workforce personnel for one or more categories of workforce personnel, wherein the given workforce selection policy specifies at least a first security skillset grade required for a first category of workforce personnel and a second security skillset grade required for a second category of workforce personnel.

17. The non-transitory processor-readable storage medium of claim 15, wherein the security weight assigned to the given microservice comprises a given microservice criticality classification, of a plurality of microservice criticality classifications, based at least in part on the aggregating the one or more security weights for the respective ones of the one or more application programming interfaces of the given microservice.

18. (canceled)

19. The non-transitory processor-readable storage medium of claim 15, wherein the one or more security weights for the respective ones of the one or more application programming interfaces of the given microservice are obtained from one or more vulnerability data sources.

20. The non-transitory processor-readable storage medium of claim 15, wherein the at least one automated action comprises one or more of: generating one or more notifications related to the selection; generating one or more signals related to the selection; and controlling a performance of at least one action in another system using the selection.

21. The method of claim 1, wherein the automatically denying further comprises an indication that one or more of the selected workforce personnel does not have the security skillset grade specified in the given workforce selection policy applicable to the given microservice.

22. The method of claim 1, wherein the at least one automated action further comprises initiating an additional training of the selected workforce personnel that does not have the security skillset grade specified in the given workforce selection policy applicable to the given microservice.

23. The apparatus of claim 9, wherein the at least one automated action further comprises initiating an additional training of the selected workforce personnel that does not have the security skillset grade specified in the given workforce selection policy applicable to the given microservice.

24. The non-transitory processor-readable storage medium of claim 15, wherein the at least one automated action further comprises initiating an additional training of the selected workforce personnel that does not have the security skillset grade specified in the given workforce selection policy applicable to the given microservice.
